(19) United States
(12) Patent Application Publication
(10) Pub. No.: US 2015/0199727 A1
(43) Pub. Date: Jul. 16, 2015

(54) Sponsoring Brands Detected in User-Generated Social Networking Content

(71) Applicant: Facebook, Inc., Menlo Park, CA (US)

(72) Inventor: Barak Naveh, Hod Hasharon (IL)

(73) Assignee: Facebook, Inc., Menlo Park, CA (US)

(21) Appl. No.: 14/152,920

(22) Filed: Jan. 10, 2014

(51) Int. Cl. G06Q 30/02; G06Q 50/00

(52) U.S. Cl. CPC G06Q 30/0269; G06Q 50/01

(57) ABSTRACT

A social networking system identifies user-generated content that can be sponsored to social networking system users based on compensation received from advertisers. Such user-generated content includes photographs, videos, audio files, and so on, that contain advertisable or promotional information such as brands, trademark names, logos, identifiers for product makes or models, or product names that an advertiser may wish to promote. The system tags such user-generated content with the identified promotional or advertisable information. The system matches the tagged content to a sponsor request from an advertiser based on the tag of the tagged content item. The system ranks the tagged content item relative to other non-sponsored content for display to social networking system users, the tagged content ranked higher than the other non-sponsored content based on the tagged content matching the sponsor request.

### BACKGROUND

This disclosure relates generally to social networking systems, and more specifically to advertising via a social networking system.

Social networks, or social utilities that track and enable connections between users (including people, businesses, and other entities), have become prevalent in recent years and allow users to communicate information more efficiently. Users, such as advertisers, may advertise their brands, products, events or otherwise communicate and disseminate advertisement content to other users via a social networking system. For example, advertisement content may be described by stories indicating other users' interactions with the advertisement content. These stories may be included in newsfeeds presented to social networking system users connected to users performing the interactions.

Social networking system users may create or otherwise share a variety of content—including a comment, a post, a status update, a photograph, a video, an audio recording, a link to an external website, a gaming application achievement, a check-in event at a local business, or any other type of content—via the social networking system. Frequently, users may generate, upload, or share content, such as photographs, audio or video files, geo-tagged content and so on, which contains promotional information associated with an advertiser. For example, users may capture, upload, and share with other social networking system users photographs, audio recordings, or video recordings containing prominent logos, brand-names, trademarks, pictures of branded objects, audio recordings with trademark jingles, and so on.

However, traditional methods for advertising via social networking systems do not enable advertisement systems to identify and leverage such promotional information embedded in user-generated content, for the purpose of distributing and advertising to other users of the social networking system. As a result, these traditional approaches to advertising do not provide a way for advertisement systems to actively promote and advertise—over other non-sponsored content—user-generated content that has embedded within promotional or advertisable information, in return for monetary compensation from advertisers.

### SUMMARY

In some embodiments, an advertising system identifies user-generated content that can be sponsored to social networking system users based on compensation received from advertisers. Such user-generated content includes photographs, videos, audio files, and so on that contain advertisable or promotional information, including brand names, trademarks, logos, identifiers for product makes or models, or product names that an advertiser may wish to promote or publicize. The advertising system tags such user-provided content with the identified promotional or advertisable information. The advertising system receives sponsor requests from advertisers to sponsor content having specific tags representing promotional information associated with the advertisers. These sponsor requests may include sponsor bids corresponding to a monetary compensation that the advertisers are willing to provide the social networking system in return for sponsoring or presenting content items with specific tags to social networking system users. Tagged content items that match an advertiser specified sponsor request are ranked relative to other non-sponsored content items when determining selection of content to be displayed to users of the social networking system, for example, in a viewing user's newsfeed or in any other suitable context or venue in which ranked or ordered content is presented. Sponsored content items are boosted in the rankings to increase the likelihood of being selected for presentation to a user (e.g., in a newsfeed) or to improve a position in a listing or ordering of content displayed to viewing users of the social networking system.

Additionally, in some embodiments, rankings of the tagged content may be modified based on one or more quality parameters of the promotional information in the tagged content. Such quality parameters for promotional information in image or video content include image resolution, color gamut, sharpness, contrast, saturation, clarity, and so on. Similarly, quality parameters for promotional information in the case of audio recordings (speech or musical recordings) may include clarity, loudness, audibility over background noise, and the like.

Furthermore, in some embodiments, one or more social networking system users may have interacted with (e.g., commented on or expressed their views on) the tagged content item or on the promotional information embedded therein. A statistical representation of sentiments associated with such interactions or views (e.g., positive sentiments versus negative sentiments) of users may also be used to determine relative rankings and placement of the tagged content. For example, a content item tagged with promotional information that receives a greater measure of interactions with positive sentiments may be ranked higher (e.g., displayed more prominently) than a content item containing tagged promotional information that receives a lower measure of interactions with positive sentiments.

### BRIEF DESCRIPTION OF THE DRAWINGS

FIG. 1 is a block diagram of a system environment in which a social networking system operates, in accordance with some embodiments.

FIG. 2 is a block diagram of a social networking system, in accordance with some embodiments.

FIGS. 3-4 include examples of user interfaces illustrating display of ranked content items containing tagged promotional information in album views for display to one or more users of the social networking system, in accordance with some embodiments.

FIG. 5 includes an example user interface illustrating ranked content items containing tagged promotional information displayed in a newsfeed to users connected via the social networking system to the user generating such content items, in accordance with some embodiments.

FIG. 6 includes an example of a user interface for displaying ranked content items containing promotional information in a timeline view displayed in conjunction with a profile of the user generating such content items, in accordance with some embodiments.

FIGS. 7a and 7b include a flowchart of a method for sponsoring brands based on user-generated social networking content, in accordance with some embodiments.

The figures depict various embodiments for purposes of illustration only. One skilled in the art will readily recognize from the following discussion that alternative embodiments of the structures and methods illustrated herein may be employed without departing from the principles of the embodiments described herein.

### DETAILED DESCRIPTION

### System Architecture

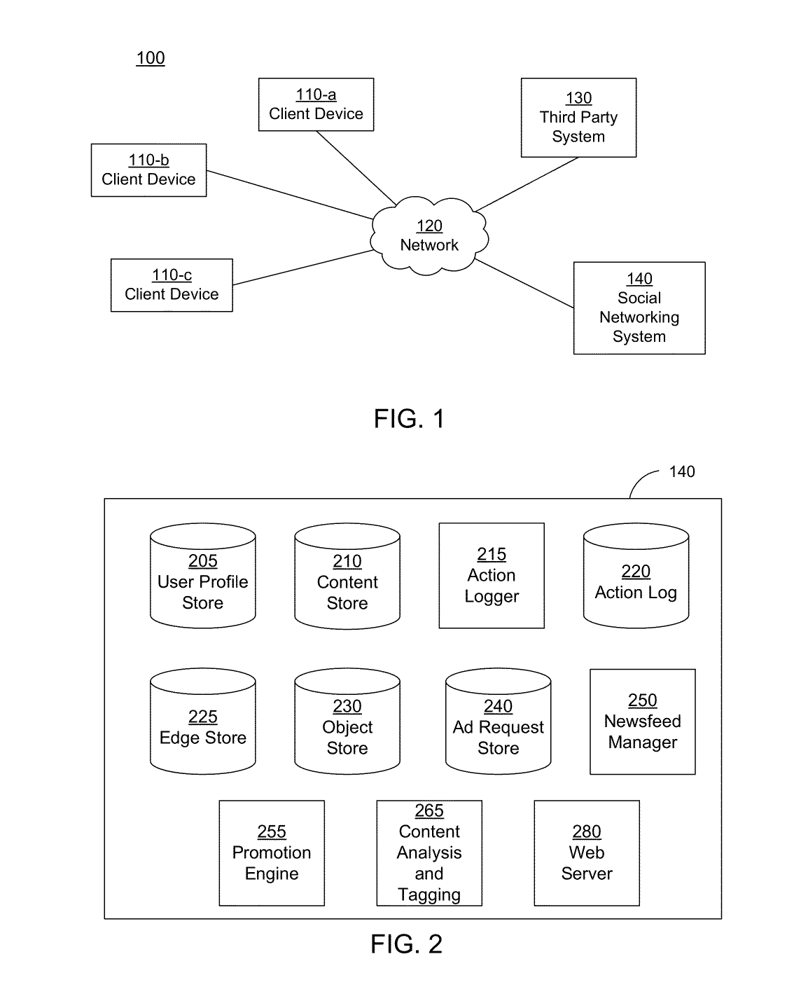

FIG. 1 is a high level block diagram of a system environment 100 for a social networking system 140. The system environment 100 shown by FIG. 1 comprises one or more client devices 110, a network 120, one or more third-party systems 130, and the social networking system 140. In alternative configurations, different and/or additional components may be included in the system environment 100. The embodiments described herein can be adapted to online systems that are not social networking systems.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the social networking system 140. For example, a client device 110 executes a browser application to enable interaction between the client device 110 and the social networking system 140 via the network 120. In another embodiment, a client device 110 interacts with the social networking system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the social networking system 140, which is further described below in conjunction with FIG. 1. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party website 130 may also communicate information to the social networking system 140, such as advertisements, content, or information about an application provided by the third party website 130.

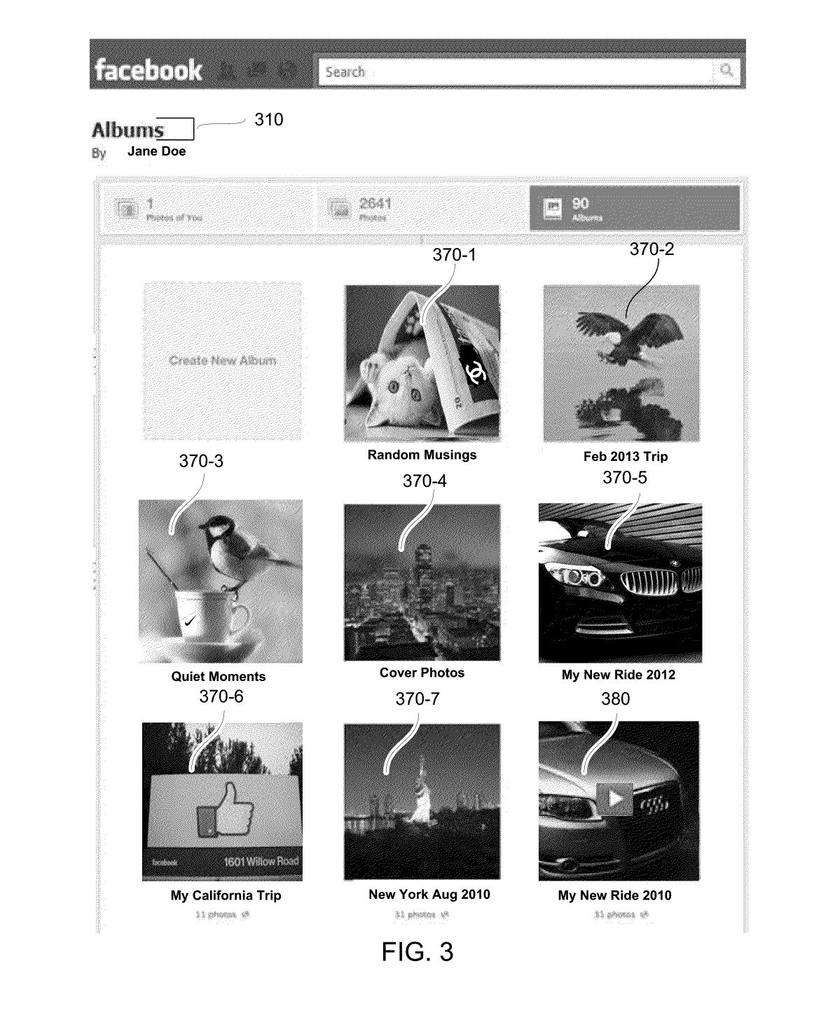

FIG. 2 is an example block diagram of an architecture of the social networking system 140. The social networking system 140 shown in FIG. 2 includes a user profile store 205, a content store 210, an action logger 215, an action log 220, an edge store 225, an object store 230, ad request store 240, newsfeed manager 250, and a web server 280. In other embodiments, the social networking system 140 may include additional, fewer, or different components for various applications. Conventional components such as network interfaces, security functions, load balancers, failover servers, management and network operations consoles, and the like are not shown so as to not obscure the details of the system architecture.

Each user of the social networking system 140 is associated with a user profile, which is stored in the user profile store 205. A user profile includes declarative information about the user that was explicitly shared by the user and may also include profile information inferred by the social networking system 140. In one embodiment, a user profile includes multiple data fields, each describing one or more attributes of the corresponding social networking system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the social networking system users displayed in an image. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the social networking system 140, user profiles may also be stored for entities such as businesses or organizations. This allows an entity to establish a presence on the social networking system 140 for connecting and exchanging content with other social networking system users. The entity may post information about itself, about its products or provide other information to users of the social networking system using a brand page associated with the entity's user profile. Other users of the social networking system may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Social networking system users may create objects stored by the content store 210, such as status updates, photos tagged by users to be associated with other objects in the social networking system, events, groups or applications. In some embodiments, objects are received from third-party applications or third-party applications separate from the social networking system 140. In one embodiment, objects in the content store 210 represent single pieces of content, or content “items.” Hence, social networking system users are encouraged to communicate with each other by posting text and content items of various types of media to the social networking system 140 through various communication channels. This increases the amount of interaction of users with each other and increases the frequency with which users interact within the social networking system 140.

The action logger 215 receives communications about user actions internal to and/or external to the social networking system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the social networking system 140 to track user actions on the social networking system 140, as well as actions on third party systems 230 that communicate information to the social networking system 140. Users may interact with various objects on the social networking system 140, and information describing these interactions is stored in the action log 220. Examples of interactions with objects include: commenting on posts, sharing links, checking-in to physical locations via a mobile device, accessing content items, and any other suitable interactions. Additional examples of interactions with objects on the social networking system 140 that are included in the action log 220 include: commenting on a photo album, communicating with a user, establishing a connection with an object, joining an event to a calendar, joining a group, creating an event, authorizing an application, using an application, expressing a preference for an object (“liking” the object) and engaging in a transaction. Additionally, the action log 220 may record a user's interactions with advertisements on the social networking system 140 as well as with other applications operating on the social networking system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the social networking system 140. For example, an e-commerce website may recognize a user of a social networking system 140 through a social plug-in enabling the e-commerce website to identify the user of the social networking system 140. Because users of the social networking system 140 are uniquely identifiable, e-commerce websites, such as in the preceding example, may communicate information about a user's actions outside of the social networking system 140 to the social networking system 140 for association with the user. Hence, the action log 220 may record information about actions users perform on a third party system 130, including webpage viewing histories, advertisements that were engaged, purchases made, and other patterns from shopping and buying.

In one embodiment, the edge store 225 stores information describing connections between users and other objects on the social networking system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 140, such as expressing interest in a page on the social networking system 140, sharing a link with other users of the social networking system 140, and commenting on posts made by other users of the social networking system 140.

In one embodiment, an edge may include various features each representing characteristics of interactions between users, interactions between users and object, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the social networking system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the social networking system 140 over time to approximate a user's interest in an object or another user in the social networking system 140 based on the actions performed by the user. A user's affinity may be computed by the social networking system 140 over time to approximate a user's interest for an object, interest, or other user in the social networking system 140 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

One or more advertisement requests (“ad requests”) are included in the advertisement request store 240. An advertisement request includes advertisement content and a bid amount. The advertisement content is text, image, audio, video, or any other suitable data presented to a user. In various embodiments, the advertisement content also includes a landing page specifying a network address to which a user is directed when the advertisement is accessed. The bid amount is associated with an advertisement by an advertiser and is used to determine an expected value, such as monetary compensation, provided by an advertiser to the social networking system 140 if the advertisement is presented to a user, if the advertisement receives a user interaction, or based on any other suitable condition. For example, the bid amount specifies a monetary amount that the social networking system 140 receives from the advertiser if the advertisement is displayed and the expected value is determined by multiplying the bid amount by a probability of the advertisement being accessed.

Additionally, an advertisement request may include one or more targeting criteria specified by the advertiser. Targeting criteria included in an advertisement request specify one or more characteristics of users eligible to be presented with advertisement content in the advertisement request. For example, targeting criteria are used to identify users having user profile information, edges or actions satisfying at least one of the targeting criteria. Hence, targeting criteria allow an advertiser to identify users having specific characteristics, simplifying subsequent distribution of content to different users.

In one embodiment, the targeting criteria may specify actions or types of connections between a user and another user or object of the social networking system 140. The targeting criteria may also specify interactions between a user and objects performed external to the social networking system 140, such as on a third party system 130. For example, the targeting criteria identifies users that have taken a particular action, such as sending a message to another user, using an application, joining a group, leaving a group, joining an event, generating an event description, purchasing or reviewing a product or service using an online marketplace, requesting information from a third-party system 130, or any other suitable action. Including actions in the targeting criteria allows advertisers to further refine users eligible to be presented with content from an advertisement request. As another example, targeting criteria may identify users having a connection to another user or object or having a particular type of connection to another user or object.

Furthermore, an advertisement request may include timing information specifying a time of rendering of an advertisement to one or more users of the social networking system. Timing information included in an advertisement request specifies a specific time instance or duration of time at or during which the advertisement is displayed to one or more social networking system users eligible to be presented with advertisement content in the advertisement request.

In some embodiments, the ad request store 240 includes sponsor requests, including requests to sponsor content items tagged with specific promotional information. The sponsor requests optionally include information identifying the advertiser providing the sponsor request, promotional information based on which a tagged content item is to be sponsored, and a bid amount which specifies a monetary amount that the social networking system 140 receives from the advertiser if the tagged content is presented to one or more social networking system users.

The promotional information may include text, image, audio, video, or any other suitable form of information. The promotional information corresponds to advertisable information that the advertiser provides compensation to the social networking system to boost or present to social networking system users.

In one embodiment, the social networking system 140 identifies stories likely to be of interest to a user through a “newsfeed” presented to the user. A story presented to a user describes an action taken by an additional user connected to the user and identifies the additional user. In some embodiments, a story describing an action performed by a user may be accessible to users not connected to the user that performed the action. The newsfeed manager 250 may generate stories for presentation to a user based on information in the action log 220 and in edge store 225 or may select candidate stories included in content store 210. One or more of the candidate stories are selected and presented to a user by the newsfeed manager 250.

For example, the newsfeed manager 250 receives a request to present one or more stories to a social networking system user. The newsfeed manager 250 accesses one or more of the user profile store 205, the content store 210, the action log 220, and the edge store 230 to retrieve information about the identified user. For example, stories or other data associated with users connected to the identified user are retrieved. The retrieved stories or other data are analyzed by the newsfeed manager 250 to identify content likely to be relevant to the identified user. For example, stories associated with users not connected to the identified user or stories associated with users for which the identified user has less than a threshold affinity are discarded as candidate stories. Based on various criteria, the newsfeed manager 250 selects one or more of the candidate stories for presentation to the identified user. Additionally, the newsfeed manager 250 may select candidate stories based in part on compensation received by the social networking system 140 for presenting a candidate story to one or more users. This allows an advertiser or other entity to sponsor a story for presentation to social networking system users. Examples of stories sponsored by advertisers or entities (“sponsored stories”) are described in U.S. application Ser. No. 12/193,702, filed Aug. 18, 2008, published as U.S. Patent Application Publication No. 2009/0119167, which is incorporated in its entirety by reference herein.

In various embodiments, the newsfeed manager 250 presents stories to a user through a newsfeed including a plurality of stories selected for presentation to the user. The newsfeed may include a limited number of stories or may include a complete set of candidate stories. The number of stories included in a newsfeed may be determined in part by a user preference included in user profile store 205. The newsfeed manager 250 may also determine the order in which selected stories are presented via the newsfeed. For example, the newsfeed manager 250 determines that a user has a highest affinity for a specific user and increases the number of stories in the newsfeed associated with the specific user or modifies the positions in the newsfeed where stories associated with the specific user are presented.

The newsfeed manager 250 may also account for actions by a user indicating a preference for types of stories and selects stories having the same, or similar, types for inclusion in the newsfeed. Additionally, the newsfeed manager 250 may analyze stories received by social networking system 120 from various users to obtain information about user preferences or actions from the analyzed stories. This information may be used to refine subsequent selection of stories for newsfeeds presented to various users.

The promotion engine 255 stores data for customizing distribution of content associated with the object. For example, the promotion engine 255 accesses the user profile store 205 to identify users having one or more characteristics identified by targeting criteria stored in the promotion engine 255. As another example, the promotion engine 255 may also access stored budget information or bid amounts associated with stories, or other content, and provide the newsfeed manager 250 with the bid amounts and/or budgets for use in generating a ranked list of stories based on budget and/or bid amount. Additionally, the promotion engine 255 may request payment information from a promoting user for placing a bid amount associated with a story (e.g., payment to promote or boost a story containing content tagged with promotional information that matches a sponsor request from an advertiser).

In some embodiments, the promotion engine 255 may communicate content associated with an object being promoted to client devices 110 of viewing users (e.g., communicate content tagged with promotional information that matches a sponsor request from an advertiser). For example, if the content is a sponsored story or other advertisement the promote engine 255 may serve the sponsored story based on data associated with it, such as targeting criteria, bid amount, or similar data. Hence, the data provided by a user authorized to promote an object is stored and applied by the promotion engine 255 to modify presentation of content to viewing users, including promoting or emphasizing content tagged with promotional information that matches a sponsor request from an advertiser. The promotion engine 255 may also provide a promoting user with information describing the effectiveness of story promotion based on information from the newsfeed manager 250. For example, the promotion engine provides information describing the difference between the number of times a promoted story has been presented to viewing users and the number of times the story would have been presented to viewing users without promotion.

The content analysis and tagging module 265 analyzes content items generated by social networking system users to determine if the content items include promotional or advertisable information that an advertiser provides compensation to the social networking system to present to social networking system users. Content analysis and tagging module 265 accesses or retrieves content items (such as image content, text content, video content, audio content, and other suitable content) from content store 210 and analyzes the content using one or more of a variety of processing approaches (such as pattern recognition, audio finger printing, template matching, and the like) to identify promotional information embedded in the content. Such promotional information may correspond to graphical, audio, or video representations of brand-names, trademarks, trademark phrases, pictures of brand-labeled objects, logos, musical trademark jingles, or landmark identifiers containing promotional information.

If the content analysis and tagging module 265 identifies promotional information in a given accessed content item, then content analysis and tagging module 265 tags the given accessed content item with the promotional information. Content analysis and tagging module 265 accesses the ad request store 240 or otherwise determines whether the promotional information in the tagged content item matches promotional information in a sponsor request provided by an advertiser. If such a match is determined to exist, the content analysis and tagging module 265 identifies the tagged content item to the promotion engine 255 for promotion or boosting or presentation to social networking system users.

In some embodiments, content analysis and tagging module 265 analyzes text content corresponding to user interactions with the tagged content items containing promotional information in order to determine a statistical measure of user sentiments toward the tagged content items based on the user interactions. Various methods of sentiment analysis may be used, such as those described in U.S. application Ser. No. 13/566,016, filed Aug. 3, 2012, which is incorporated in its entirety by reference herein.

The web server 280 links the social networking system 140 via the network 120 to the one or more client devices 110, as well as to the one or more third party systems 130. The web server 280 serves web pages, as well as other web-related content, such as JAVA®, FLASH®, XML and so forth. The web server 280 may receive and route messages between the social networking system 140 and the client device 110, for example, instant messages, queued messages (e.g., email), text messages, short message service (SMS) messages, or messages sent using any other suitable messaging technique. A user may send a request to the web server 280 to upload information (e.g., images or videos) that are stored in the content store 210. Additionally, the web server 280 may provide application programming interface (API) functionality to send data directly to native client device operating systems, such as IOS®, ANDROID™, WEBOS®, or BlackberryOS.

### User-Generated Content and Promotional Information

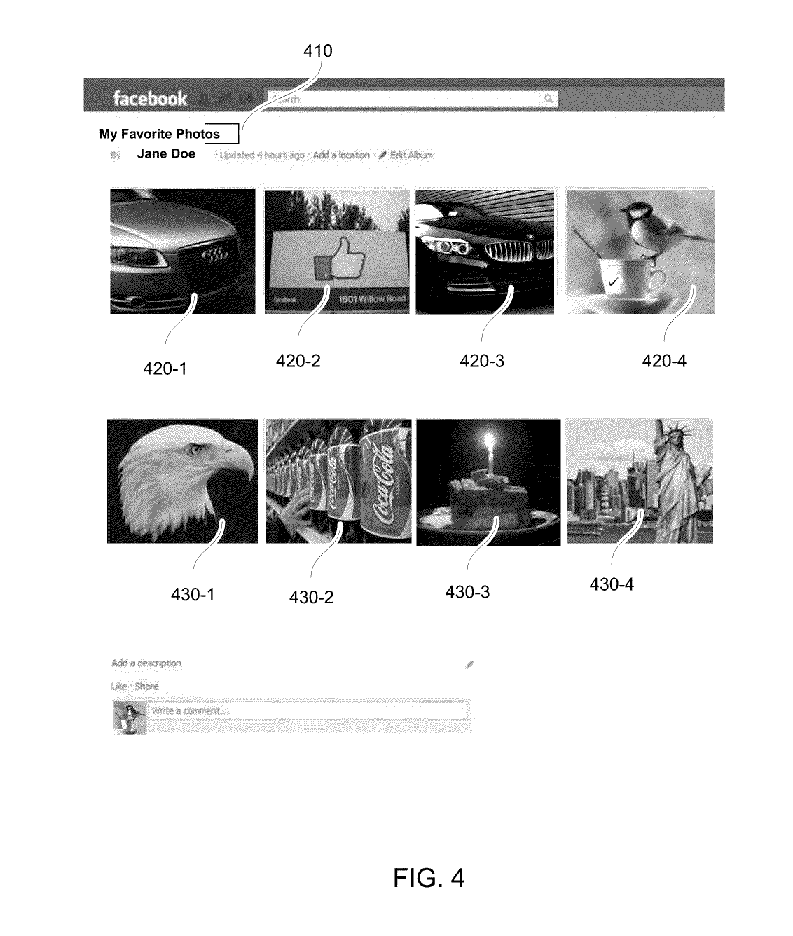

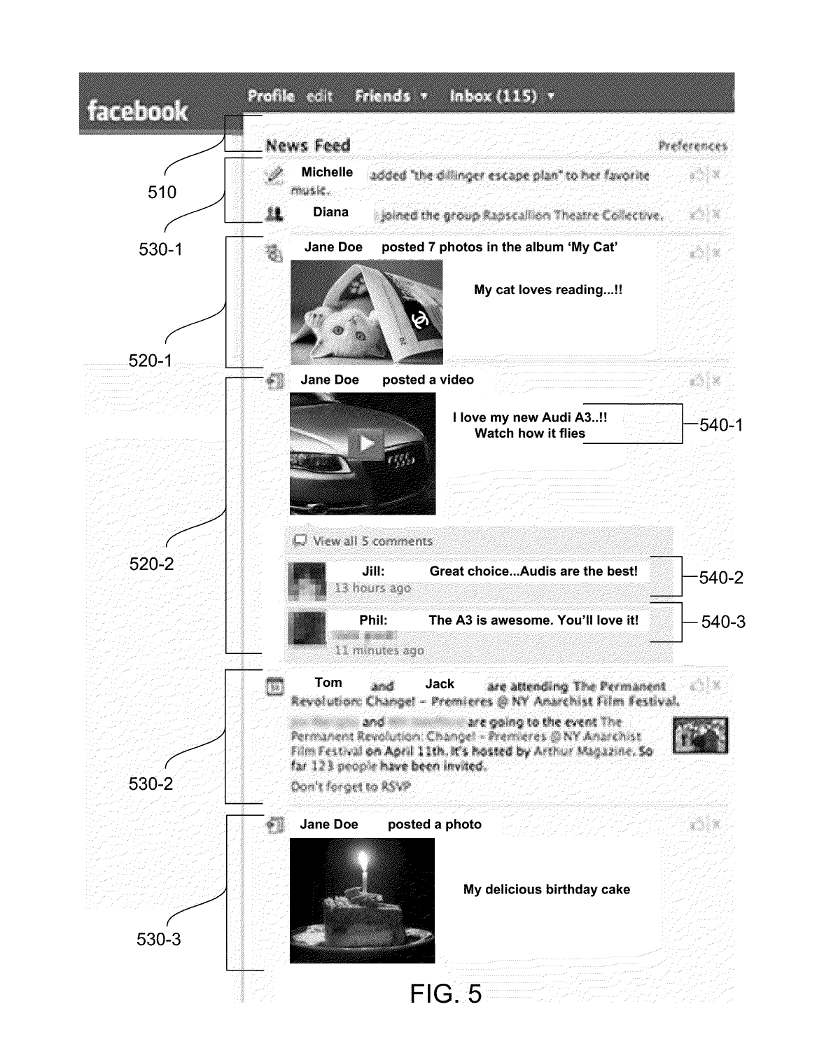

Social networking system users may create, upload, or otherwise share a variety of content—including text content (e.g., a comment, a post, a status update), graphical or image content (e.g., a photograph, or picture), video content, audio content (e.g., audio recording, musical recording, or speech recording), metadata content (e.g., a hyperlink to an external website), or other forms of mixed media content (e.g., a gaming application achievement, a check-in event at a local business), or any other suitable type of content—via the social networking system. For example, shown in FIGS. 3-4 are views of photos and videos created or uploaded by a social networking system user and organized in photo or video albums, in accordance with some embodiments.

Frequently, photographs, audio or video files, geo-tagged content and so on generated by users may contain promotional or advertisable information associated with an advertiser. Content items containing promotional information may include a still image file, an image frame extracted from a videographic file, audio content extracted from a videographic file, an audio file comprising musical recording, an audio file comprising speech, or geospatial or geo-tagged content. For example, users may capture, upload, and share with other social networking system users photographs, audio recordings, or video recordings containing audio (e.g., speech) or visual representations of brand-names, trademarks, trademark phrases, pictures of brand-labeled objects, prominent logos, musical trademark jingles, landmark identifiers containing promotional information, and so on.

In some embodiments, such promotional information optionally symbolizes, or explicitly or implicitly identifies an advertiser. The promotional information corresponds to advertisable information that the advertiser provides compensation to the social networking system to present (e.g., publicize) to social networking system users.

In some embodiments, the promotional information may include an image representation of a brand-name, an image representation of a graphical logo, or an image representation of a trademark phrase. For example, the promotional information may correspond to the brand-name or word ‘Coca Cola’ displayed in a photographic format 430-2 or the brand-name or word ‘facebook’ displayed in photo 370-6 or 420-2 shown in FIGS. 3-4. Similarly, the promotional information may include a picture of a graphical logo, for example, pictures of the official logos of Audi in 420-1, BMW in 370-5 and 420-3, Nike in 370-3 and 420-4, or Chanel in 370-1 shown in FIGS. 3-4.

These logos or brand-names may be displayed on objects represented or branded by these brand names (such as the Audi branded car in 420-1, the BMW branded car in 370-5, the Nike branded tea cup in 370-3), or may be located on a hand-held banner or wall posting captured in a photograph such as the ‘like’ trademark or logo, or the ‘facebook’ brand-name displayed on a wall in 370-6. Alternatively, such promotional information may be displayed in any other suitable context in a photograph, such as a Chanel logo printed in a newspaper and (e.g., inadvertently) captured by a user when photographing the user's cat in 370-1. In some embodiments, the promotional information may also contain geographical information or geo-tagged information, such as the address of the Facebook headquarters ‘1601 Willow Road’ captured in 370-6, optionally, in a manner such that the address in itself may adequately represent or symbolize an advertiser such as Facebook.

Similarly, the promotional information may include a videographic representation of a brand-name or a videographic representation of a trademark or brand logo such as a video clip or video album 380 having one or more still image frames that contain an Audi logo.

Alternatively, or in addition, the promotional information may include an audiographic representation of a brand-name, an audiographic representation of a trademark phrase, or an audiographic representation of a trademark musical theme (e.g., a trademark jingle).

Advertisers might wish to sponsor or promote the promotional information, and optionally the content that includes the promotional information, to social networking system users in order to publicize their brand. To do so, the advertisers may provide the advertising system or the social networking system a sponsor request (e.g., containing a monetary bid) to sponsor or promote the content containing the promotional information to social networking system users.

### Analyzing and Tagging Content Containing Promotional Information

In some embodiments, the social networking system analyzes content items to identify promotional information embedded therein. For example, an image may be extracted from a still image file or a videographic file to identify a graphical representation of a logo or trademark or brand-name. In some embodiments, the promotional information is identified by detecting an object (e.g., a car) embedded within the extracted image, and identifying a brand-name or logo displayed along with the detected object (e.g., an ‘Audi’ logo on the car as shown in 420-1 of FIG. 4). Various methods of computer vision or digital image analysis and processing—such as template matching, cross-correlation, optical character recognition, or various suitable forms of pattern recognition—may be used to analyze image content in order to identify embedded promotional information.

Alternatively, an audio recording may be extracted from an audiographic file, or a videographic file to identify an utterance or other spoken representation of a brand-name or a trademark phrase in speech contained within the audio recording, or to identify a musical trademark theme in a portion of musical sound contained within the audio recording. Various approaches such as speech recognition, speech to text conversion, speech translation, audio pattern recognition, audio template matching (e.g., audio finger printing), and the like may be used to analyze such audio recordings to identify embedded promotional information.

Promotional information optionally contained in textual content provided by social networking system users (such as comments, status messages, posts, and so on) may be identified or tagged by methods such as ‘dark tagging’ further described in U.S. patent application Ser. No. 13/167,701, filed on Jun. 23, 2011, which is hereby incorporated by reference in its entirety. Such methods include determining potential meanings, and then disambiguating between potential meanings for a textual term in a communication by using a dictionary, by using surrounding words or terms for context in the communication, using global term usage, using information about a communicating user, using social context, and so on.

The content item may be tagged with a tag representing the promotional information. In the examples shown in FIGS. 3-4, the picture of 430-2 may be tagged with the brand-name ‘Coca Cola,’ or the picture of 370-6 may be tagged with the brand-name ‘facebook’ picture of 420-1 may be tagged with the official logos of Audi and so on.

Ranking Content Containing Promotional Information Based on Sponsor Requests from Advertisers

In some embodiments, the social networking system receives requests from advertisers to sponsor content items if the content items have specific tags. For example, the social networking system might receive a sponsor request from Audi indicating a request (including a corresponding bid amount) to sponsor or promote any content tagged with the Audi logo, to social networking system users. Based on such received sponsor requests, the social networking system may rank tagged content items that match the sponsor requests higher than other non-sponsored content items when selecting content for display to users of the social networking system. For example, the tagged content item that matches a sponsorship request may be displayed over, or more prominently than, other non-sponsored content items.

FIGS. 3-4 include examples of user interfaces illustrating display of ranked content items containing tagged promotional information in album views for display to one or more users of the social networking system, in accordance with some embodiments.

As shown in FIG. 3, photographs or videos uploaded by a social networking system user may be organized in the form of one or more albums 310 and displayed in conjunction with a user's social profile. Each album may include one or more pictures and/or videos collectively organized by the user based on a unifying theme, chronological sets of events captured within the photographs, sources of the pictures or videos, and so on. Such albums optionally have a name, date of creation, a cover photo, a number of content items (photos or videos) contained in the albums, and other suitable attributes. Additionally, one or more social networking system users may comment on, like, share, or otherwise interact with the albums or with individual photos within the albums. Such user interaction information may also be stored and displayed in conjunction with the albums or photos.

In some embodiments, if an album is determined to contain a tagged content item that matches a sponsorship request, the tagged content item may be displayed more prominently than, other non-sponsored content items in the album—for example, the cover photo of the album may automatically be updated to reflect the tagged content item that matches the sponsorship request (though the user may have the option to override this or opt out, as can be true for all of the embodiments described throughout). For example, the cover photo 370-1 for the ‘Random Musings’ album is selected based on image content tagged with a Chanel logo that matches a sponsorship request received by the social networking system from Chanel to sponsor content tagged with the Chanel logo. Similarly, the cover photos 370-3, 370-5, and 370-6 for the ‘Quiet Moments,’ ‘My New Ride 2012,’ and the ‘My California Trip’ albums include a Nike logo, a BMW logo, and a Facebook logo and these images are selected (or ranked) over the other images in these respective albums based on sponsorship requests received from Nike, BMW, and Facebook respectively. The cover image 380 of video album ‘My New Ride 2010’ includes a still image extracted from a video tagged with an Audi logo and is selected as the cover image based on a sponsorship request received by the social networking system from Audi to sponsor content tagged with the Audi logo.

In some embodiments, if a given album contains multiple content items with promotional information that match sponsorship requests from the same or from different advertisers, then the content item with tagged content corresponding to the highest sponsorship bid is ranked over the other content items in the album and is selected as the cover photo for the album.

Alternatively, or in addition, ranking of the tagged content may be modified based on one or more quality parameters of the promotional information in the tagged content. Such quality parameters for an image or video include image resolution, color gamut, sharpness, contrast, saturation, clarity. Similarly, quality parameters in the case of audio recordings (speech or musical recordings) may include clarity, loudness, audibility over background noise, and the like. For example, the ‘My New Ride 2010’ video album may include multiple videos and multiple still images from any given video that contain the Audi logo. But the still image selected as the cover image 380 for the album is optionally the image with the highest resolution, the largest size, and/or the best and most prominent view of the Audi logo of all other still images in the videos.

FIG. 4 illustrates a view of a single photo album 410 (named ‘My Favorite Photos’) containing multiple photos organized within the album. Typically, photos may be organized within the album in a chronological order (e.g., based on date or time of upload), in an alphabetically order (e.g., based on the photo name or photo caption), and the like. Photos within an album may contain tagged promotional information, such as photo 420-1 tagged with an Audi logo, photo 420-2 tagged with a Facebook brand-name or a ‘like’ trademark or geo-tagged address, photo 420-3 tagged with a BMW logo, photo 420-4 tagged with a Nike logo, and photo 430-2 tagged with a Coca Cola logo.

The social networking system matches the tagged promotional information with sponsorship requests received from advertisers, and ranks (e.g., determines display order) for the content items that match advertiser-provided sponsorship requests. In some embodiments, if an album has multiple tagged content items that match sponsorship requests from the same or different advertisers, the rankings or ordering may be weighted based on other factors such as quality parameters of the tagged promotional information, or a monetary value of the bid amount—tagged content having the best content quality or that matches the highest bid amount being displayed in a most prominent location (e.g., at the top or at the first location).

For example, photo 420-1 tagged with an Audi logo, photo 420-2 tagged with a Facebook brand-name or a ‘like’ trademark or geo-tagged address, photo 420-3 tagged with a BMW logo, photo 420-4 tagged with a Nike logo match sponsorship requests received from Audi, Facebook, BMW, and Nike, respectively. However, in the absence of a sponsorship request from Coca Cola, photo 430-2 tagged with a Coca Cola logo does not match any sponsorship request and is therefore displayed less prominently compared to the tagged content items 420 (including 420-1, 420-2, and the like) that do match sponsorship requests. Other non-sponsored content items 430 (including 430-1, 430-3, and the like) are also displayed less prominently than the sponsored content items 420. Again, the user may have the option to opt out of these arrangements if desired.

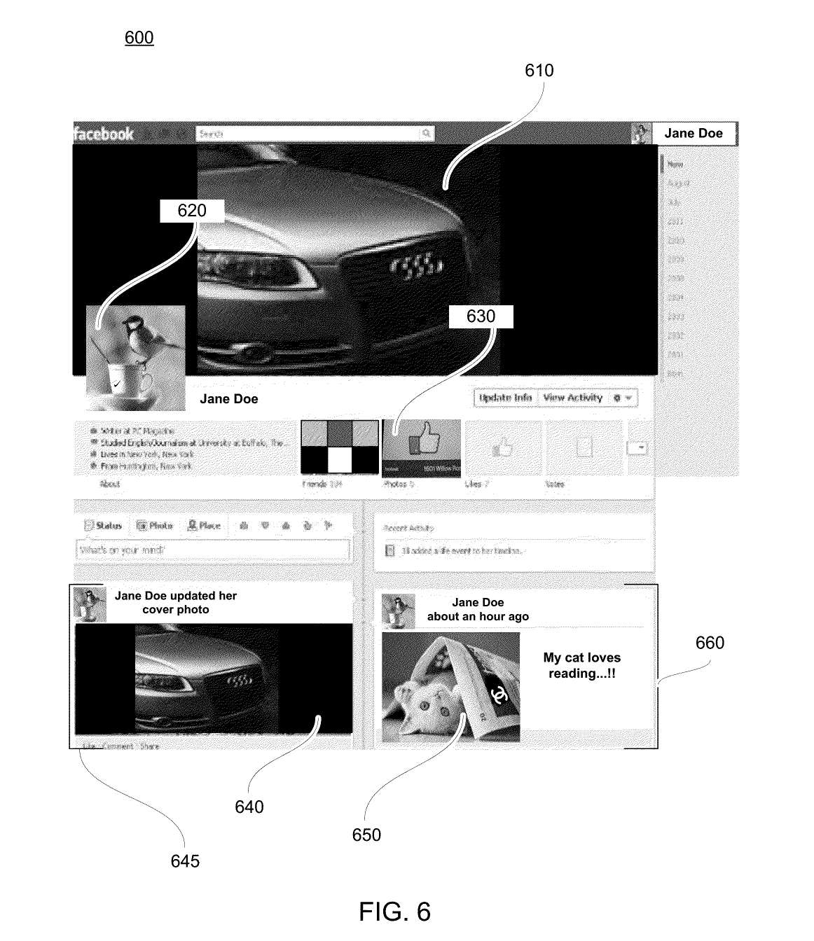

FIG. 5 includes an example user interface illustrating ranked content items containing tagged promotional information displayed in a newsfeed to users connected via the social networking system to the user generating such content items, in accordance with some embodiments.

The social networking system presents a newsfeed 510 to a viewing user of the social networking system. The newsfeed contains information about various actions performed by other social networking system users connected to the given viewing user. Information about such actions is presented to the viewing user in the form of organic content or “stories” ordered for presentation to the viewing user based on factors such as chronology (e.g., placement of content in the newsfeed may be modified based on a time of creation or sharing of the content by users generating the content), measures of affinity (e.g., the number and/or placement of stories from a particular user is modified based on an affinity of the viewing user with that particular user), presentation preferences or content filters specified by the given viewing user, and so on.

In some embodiments, tagged content containing promotional information that matches advertiser-specified sponsor requests (e.g., content items included within stories 520, including story 520-1 and 520-2) is presented to one or more social networking system users in the form of stories displayed in a newsfeed 510.

In some embodiments, the tagged content items 520 are ranked relative to other non-sponsored content items 530 for display in the newsfeed 510 so that stories containing tagged promotional information may be displayed in a more prominent portion (e.g., the top) of the newsfeed compared to other non-sponsored content or may be selected for display as a newsfeed story over non-sponsored content. For example, story 520-1 from Jane Doe containing tagged promotional information matching a sponsor request from Chanel and story 520-2 also from Jane Doe containing tagged promotional information matching a sponsor request from Audi are displayed more prominently (e.g., higher, near a top region) in the newsfeed 510 compared to story 530-2 containing non-sponsored content regarding actions performed by Tom and Jack or story 530-3 containing a non-tagged, non-sponsored photo posted by Jane Doe.

In some embodiments, a tagged content item matching an advertiser specified sponsor request and generated by a particular user is selected for display, in a newsfeed story presented to one or more other viewing users, over other non-sponsored content items generated by the same particular user and represented by the same newsfeed story. For example, as described by the caption for newsfeed story 520-1, Jane Doe uploads or posts 7 photos in her album ‘My Cat,’ but the photo item selected for display or for more prominent display to the viewing user in the newsfeed is the photo containing tagged promotional information (a Chanel logo) matching a sponsor request from Chanel over other non-sponsored content. Jane Doe may have the option to opt out of this if desired.

A weighting of the tagged content items that matches sponsor requests and corresponding stories 520 may be adjusted in proportion to weights ascribed to other factors such as chronology, affinity, and content filters or preferences of the viewing user, when determining an order for displaying stories in the newsfeed 510. For example, non-sponsored stories 530-2 and 530-3 generated based on actions performed by Tom, and Jack may be ranked lower than story 520-1 from Jane Doe containing tagged promotional information that matches a sponsor request from Chanel. In this case, the bid for story 520-1 from Chanel outweighs the effect of the measure of affinities between the viewing user and Tom or Jack. However, conversely, non-sponsored stories 530-1 generated based on actions performed by Michelle and Diana may be ranked higher than story 520-1 from Jane Doe containing tagged promotional information, either based on the viewing user having a higher measure of affinity with Michelle than with Jane such that the higher measure of affinity with Michelle outweighs the effect of (and weighting assigned to) the bid for story 520-1 from Jane containing the tagged promotional information. Continuing along this example, in some embodiments, if the bid value in a sponsor request from Chanel associated with the story 520-1 is increased above a certain bid threshold, then the effect of the bid in the sponsor request would outweigh the effect of affinity between the viewing user and either Michelle or Diana, on the relative placements. Accordingly, responsive to the increased bid from Chanel, the relative ranking and placement of the corresponding tagged content in 520-1 would be raised to a value higher than the ranking and placement of, for example, the non-sponsored content in 530-1.

Furthermore, various factors may be considered when evaluating relative rankings and placement of content items that are tagged with promotional information that match sponsor requests. For example, a story containing promotional information associated with a higher bid may be selected for placement over or placed more prominently than a story containing promotional information associated with a lower bid. For example, if the bid value in a sponsor request from Chanel associated with the story 520-1 is higher than the bid value in a sponsor request from Audi associated with the story 520-2, then story 520-1 would be placed higher than the story 520-2 in the newsfeed 510. Quality parameters of the tagged promotional information may also be used to evaluate such relative rankings (as explained with reference to FIGS. 3-4).

One or more social networking system users that are connected to the viewing user may have interacted with the story 520 or with the content item tagged with promotional information. For example, the user generating the tagged content item may provide a caption 540-1 describing the content item or their views on the advertiser or on the promotional information. Similarly, other social networking system users may interact with or express views on the tagged content item, on the advertiser, or on the promotional information by way of comments 540-2 and 540-3 provided in associated with the tagged content item. A statistical representation of the sentiments associated with such interactions or views (e.g., positive sentiments versus negative sentiments) of the viewing users may also be used to determine relative rankings and placement of the tagged content in the newsfeed 510. For example, a story containing tagged promotional information that receives greater measure (e.g., number, ratio, or percentage) of interactions with positive sentiments may be ranked higher (e.g., displayed more prominently) than a story containing tagged promotional information that receives a lower measure (e.g., percentage) of interactions with positive sentiments. Additionally, in some embodiments, a story containing tagged promotional information that receives a measure (e.g., percentage) of interactions with positive sentiments greater than a specified threshold is selected for display in a newsfeed. For example, the story 520-2 includes user interactions (e.g., comments 540-1, 540-2, and 540-3) with predominantly positive sentiments regarding the promotional information in the tagged content item. Conversely, a story containing tagged promotional information that receives a lower measure (e.g., percentage) of interactions with positive sentiments than the specified threshold may not be selected for display in a viewing user's newsfeed or may be ranked lower.

Examples of user interactions with the story or the content item may generally include providing a comment associated with the story or the content item, expressing a preference for the story or the content item (e.g., “liking” the story or the content item), sharing the story or the content item with another social networking system user, or any other suitable interaction.

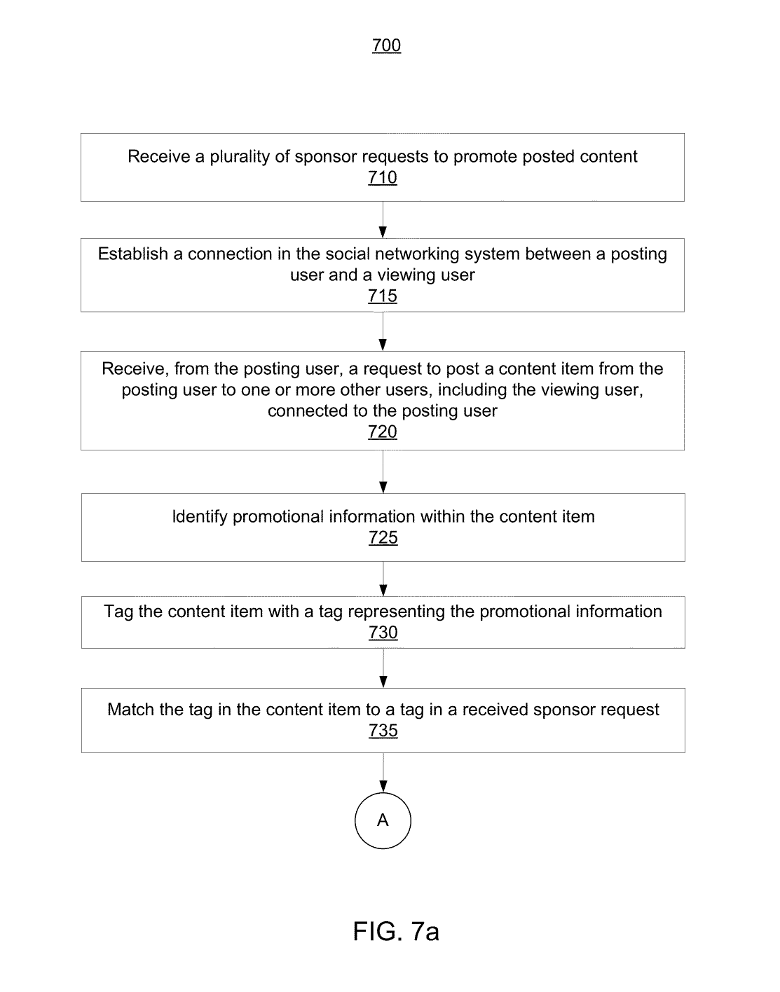

FIG. 6 includes an example of a user interface for displaying ranked content items containing promotional information in a timeline view displayed in conjunction with a profile of the user generating such content items, in accordance with some embodiments.

Over and above the album views shown in FIGS. 3-4, photos and videos may be displayed on a user's social networking profile in various other contexts and spatial regions of the user's profile. Ranking and display locations of content items with tagged promotional information may be determined in a variety of these contexts and regions of the user's profile if the tagged content items match sponsor requests from advertisers.

For example, various types of information are displayed in conjunction with a user's social networking profile in the form of a timeline view 600 (shown in FIG. 6). The timeline view contains information and updates about a particular user's activities as well as activities performed by other users connected to the particular user, typically organized in a reverse chronological order.

Content items tagged with promotional information that match sponsor requests from advertisers (or stories containing such tagged content items) may be displayed in a viewing user's timeline view 600 in more prominent locations (e.g., near the top) of the timeline view compared to non-sponsored content, in a display area larger than the typical display area for non-sponsored content, or be made prominent in any other suitable manner. For example, the stories 645 and 660 containing tagged photos 640 and 650, respectively, with promotional information about Audi and Chanel, are displayed in prominent locations of the timeline 600. The tagged content items may also be selected as a cover photo 630 representing the collective photo selection for the particular user.

The user may optionally be prompted by the social networking system to select a tagged content item (that matches an advertiser's sponsor request) as a profile picture 620 or as a cover photo 610 for display on the user's timeline view 600.

### Sponsoring Brands Based on User-Generated Social Networking Content

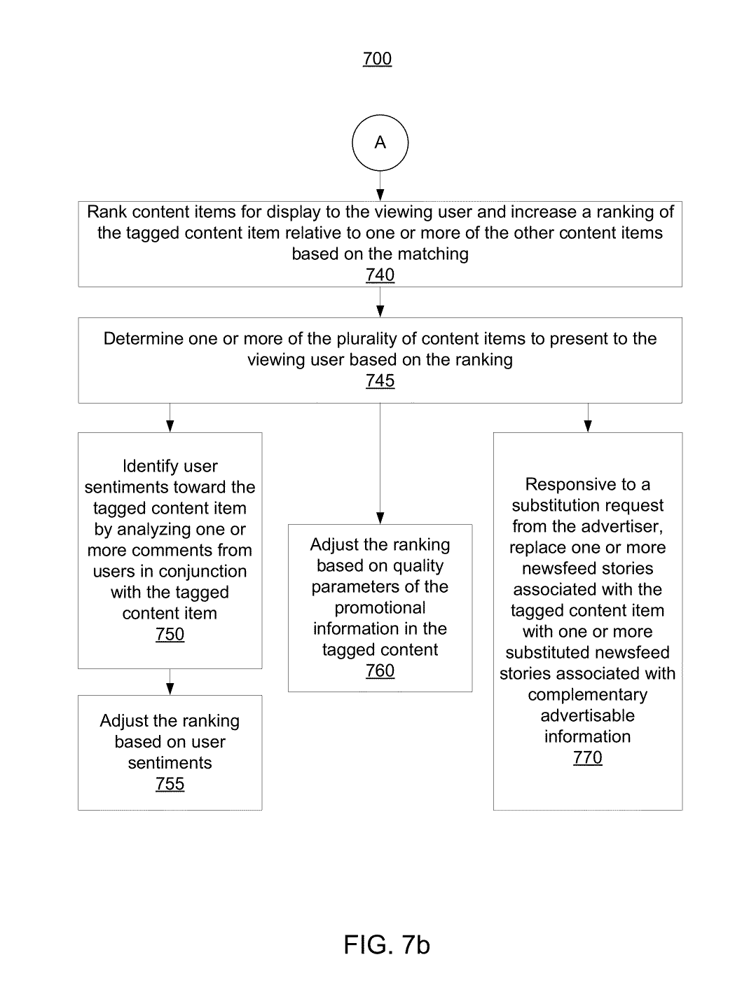

FIGS. 7a and 7b include a flowchart of one embodiment of a method 700 for sponsoring brands based on user-generated social networking content, according to some embodiments.

The social networking system receives 710 a plurality of sponsor requests to promote content posted in a social networking system in exchange for compensation, each sponsor request specifying one or more tags that identify posted content to be sponsored.

The social networking system establishes 715 a connection in the social networking system between a posting user of a plurality of users of the social networking system and a viewing user of the plurality of users. In some embodiments, a posting user is a social networking system user who generates, uploads, shares, or otherwise posts content to the social networking system. A viewing user is optionally a user who views, accesses or is provided access to content posted by another social networking system user.

The social networking system receives 720 from the posting user a request to post a content item from the posting user to one or more other users of the social networking system who have established a connection to the posting user (e.g., friends of the posting user), the one or more other users comprising the viewing user.

The social networking system identifies 725 promotional information within the content item. In some embodiments, the social networking system analyzes the content item provided by the posting user to identify promotional information in the content item.

The promotional information optionally symbolizes or identifies an advertiser. In some embodiments, the promotional information corresponds to advertisable information that the advertiser provides compensation to the social networking system to present (e.g., boost or publicize) to social networking system users. In some embodiments, the content item is a still image file, an image frame extracted from a videographic file, audio content extracted from a videographic file, an audio file comprising musical recording, an audio file comprising speech, or geospatial (geo-tagged) content. In some embodiments, as explained with reference to FIGS. 3-4, the promotional information is an image representation of a brand-name, an image representation of a trademark phrase, or an image representation of a graphical logo. In some embodiments, the promotional information is a videographic representation of a brand-name or a videographic representation of a trademark. In some embodiments, the promotional information is an audiographic representation of a brand-name, an audiographic representation of a trademark phrase, or an audiographic representation of a trademark musical theme (e.g., a trademark jingle).

In some embodiments, the content item is an image extracted from a still image file or a videographic file. In such embodiments, the promotional information is identified by detecting an object (e.g., a car, as shown in content item 420-1 in FIG. 4) embedded within the extracted image and identifying a brand-name or trademark displayed, in the extracted image, in conjunction with the detected object (e.g., a ‘Honda’ brand-label on a car, or an ‘Audi’ logo on the car in 420-1 in FIG. 4), the brand-name or trademark identifying the advertiser.

In some embodiments, the content item is an audio recording extracted from an audiographic file or a videographic file. In such embodiments, the promotional information is identified by detecting one or more portions of speech embedded within the audio recording and identifying a vocal utterance or spoken representation of a brand-name or a trademark phrase in the detected portions of speech, the brand-name or the trademark phrase identifying the advertiser. In some embodiments, the detected portions of speech are converted into corresponding textual representations and the brand-name or the trademark phrase is identified from the corresponding textual representations of the detected speech portions. In some embodiments, the detected portions of speech are translated from a first language to a second language and the brand-name or the trademark phrase is identified, in the second language, in the translated portions of speech.

In some embodiments, the content item is an audio recording extracted from an audiographic file or a videographic file. In such embodiments, the promotional information is identified by detecting one or more portions of musical sound embedded within the audio recording, and identifying a musical trademark theme in the detected portions of musical sound, the musical trademark theme symbolizing the advertiser.

The social networking system tags 730 the content item with one or more tags representing the promotional information identified in the content item.

The social networking system matches 735 the one or more tags of the tagged content item to one or more tags of a sponsor request of the plurality of received sponsor requests. In some embodiments, the tagged content item is matched to a sponsor request of an advertiser based on the tag of the tagged content item. In some embodiments, the sponsor request is one of a plurality of requests from advertisers to sponsor content items based on the content items having specific tags. In some embodiments, the sponsor request includes a bid amount corresponding to a monetary compensation provided by the advertiser to the social networking system if the tagged content is presented to one or more users of the social networking system.

The social networking system ranks 740 content items, including the tagged content item, for display to the viewing user. In some embodiments, a ranking of the tagged content item is increased relative to one or more of the other content items based on the tagged content item being tagged with a tag that matches a tag of the sponsor request. In some embodiments, the tagged content item is ranked relative to other non-sponsored content items for display to users of the social networking system. As described with reference to FIGS. 3-6, the tagged content item is ranked higher than the other non-sponsored content items based on the tagged content item matching the one of the sponsor requests provided by advertisers to the social networking system.

The social networking system determines 745 one or more of the plurality of content items to present to the viewing user based on the ranking.

In some embodiments, the social networking system displays the tagged content item in an album view (e.g., as the cover photo of an album in the user's own album selection as explained with reference to FIG. 3; in a prominent display location within a given album in an album view, as explained with reference to FIG. 4; or in a prominent place in the user's own profile page or timeline view, as explained with reference to FIG. 6), displayed to one or more of the users of the social networking system in conjunction with the user's profile page more prominently than the other non-sponsored content items in the album view.

In some embodiments, as explained with reference to FIG. 5, the social networking system displays the tagged content item in a newsfeed presented to one or more of the users of the social networking system in spatial locations more prominent than display locations for the other non-sponsored content items in the newsfeed, such as in a top region of a viewing user's newsfeed.

In some embodiments, when determining relative rankings for display to users of the social networking system, the social networking system adjusts a weighting of the tagged content item in proportion to weights ascribed to one or more other factors (e.g., including affinity, chronology, display preferences or content filters specified by a viewing user, and the like; as explained with reference to FIG. 5) for the tagged content item when compared to corresponding weights ascribed to the one or more other factors for the other non-sponsored content items.

In some embodiments, and as explained with reference to FIG. 5, the social networking system identifies 750 a statistical representation of user sentiments (e.g., positive versus negative sentiments) toward the tagged content item by analyzing one or more comments (such as comments 540-1, 540-2, and 540-3) received from social networking system users in conjunction with the tagged content item to. The social networking system adjusts 755 the ranking of the tagged content item based on the statistical representation of user sentiments toward the tagged content item. In some embodiments, the ranking of the tagged content item is adjusted toward a higher rank if the statistical representation of user sentiments toward the tagged content item is positive; and the ranking of the tagged content item is adjusted toward a lower rank, if the statistical representation of user sentiments toward the tagged content item is negative.

In some embodiments, and as explained with reference to FIGS. 3-4, the social networking system adjusts 760 the ranking of the tagged content based on one or more quality parameters of the promotional information in the tagged content. Examples of such quality parameters for promotional information in image or video content include image resolution, color gamut, sharpness, contrast, saturation, clarity, and the like. Examples of such quality parameters for promotional information in audio or speech include clarity, loudness, audibility over background noise, and the like.

In some embodiments, responsive to a substitution request from the advertiser (e.g., an advertiser associated with the sponsor request), the social networking system replaces 770, for display to users of the social networking system, one or more newsfeed stories associated with the tagged content item with one or more substituted newsfeed stories associated with complementary advertisable information to advertisable information represented by the promotional information in the tagged content item. For example, the social networking system may substitute a story or post in a viewing user's newsfeed corresponding to promotional information about a first product (e.g., Audi A1) with another story 520-2 (shown in FIG. 5) or post regarding another product (e.g., Audi A3), based on a substitution request from the advertiser (in this case, Audi).

### SUMMARY

The foregoing description of the embodiments has been presented for the purpose of illustration; it is not intended to be exhaustive or to limit the embodiments to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Some embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Some embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the embodiments be limited not by this detailed description, but rather by any claims that issue on an application based hereon. Accordingly, the disclosure of the embodiments are intended to be illustrative, but not limiting, of the scope of the embodiments, which is set forth in the following claims.

What is claimed is:

1. A method comprising:
identifying promotional information within a content item posted on a social networking system;
tagging the content item with one or more tags representing the promotional information identified in the content item;
matching the one or more tags of the tagged content item to one or more tags of a sponsor request to promote content in the social networking system in exchange for compensation, the sponsor request specifying one or more tags that identify posted content to be sponsored;
ranking a plurality of content items for display to a viewing user, the plurality of content items including the tagged content item, wherein the ranking increases a ranking of the tagged content item relative to one or more of the other of the plurality of content items based on the tagged content item being tagged with a tag that matches a tag of the sponsor request; and
determining one or more of the plurality of content items to present to the viewing user based on the ranking.

2. The method of claim 1, wherein the promotional information corresponds to advertisable information that an advertiser provides compensation to the social networking system to present to social networking system users.

3. The method of claim 1, wherein the content item comprises one or more of: a still image file, an image frame extracted from a videographic file, audio content extracted from a videographic file, an audio file comprising musical recording, an audio file comprising speech, or geospatial content.

4. The method of claim 1, wherein the promotional information comprises one or more of: an image representation of a brand-name, a videographic representation of a brand-name, an audiographic representation of a brand-name, an image representation of a graphical logo, a videographic representation of a trademark, an image representation of a trademark phrase, an audiographic representation of a trademark phrase, or an audiographic representation of a trademark musical theme.

5. The method of claim 1, wherein the content item comprises an image extracted from a still image file or a videographic file, and wherein identifying the promotional information comprises:
detecting an object embedded within the extracted image, and
identifying a brand-name displayed, in the extracted image, in conjunction with the detected object, the brand-name identifying an advertiser.

6. The method of claim 1, wherein the content item comprises an audio recording extracted from an audiographic file, or a videographic file and wherein
identifying the promotional information comprises:
detecting one or more portions of speech embedded within the audio recording, and
identifying a spoken representation of a brand-name or a trademark phrase in the detected portions of speech, the brand-name or the trademark phrase identifying an advertiser.

7. The method of claim 6, wherein identifying the spoken representation of the brand-name or the trademark phrase in the detected portions of speech comprises:
converting the detected portions of speech into corresponding textual representation; and
identifying the brand-name or the trademark phrase in the corresponding textual representation.

8. The method of claim 6, wherein identifying the spoken representation of the brand-name or the trademark phrase in the detected portions of speech comprises:
translating the detected portions of speech from a first language to a second language; and
identifying, in the second language, the brand-name or the trademark phrase in the translated portions of speech.

9. The method of claim 1, wherein the content item comprises an audio recording extracted from an audiographic file, or a videographic file and wherein identifying the promotional information comprises:
detecting one or more portions of musical sound embedded within the audio recording, and
identifying a musical trademark theme in the detected portions of musical sound, the musical trademark theme symbolizing an advertiser.

10. The method of claim 1, further comprising:
identifying a statistical representation of user sentiments toward the tagged content item by analyzing one or more comments received from social networking system users in conjunction with the tagged content item; and
adjusting the ranking of the tagged content item based on the statistical representation of user sentiments toward the tagged content item.

11. The method of claim 10, further comprising:
adjusting the ranking of the tagged content item toward a higher rank, if the statistical representation of user sentiments toward the tagged content item is positive; and
adjusting the ranking of the tagged content item toward a lower rank, if the statistical representation of user sentiments toward the tagged content item is negative.

12. The method of claim 1, wherein determining one or more of the plurality of content items to present to the viewing user based on the ranking comprises:
displaying the tagged content item in a newsfeed presented to one or more of the users of the social networking system in spatial locations more prominent than display locations for the one or more of the other of the plurality of content items in the newsfeed.

13. The method of claim 1, wherein determining one or more of the plurality of content items to present to the viewing user based on the ranking comprises:
adjusting a weighting of the tagged content item in proportion to weights ascribed to one or more other factors for the tagged content item when compared to corresponding weights ascribed to the one or more other factors for the one or more of the other of the plurality of content items.

14. The method of claim 1, wherein ranking the tagged content item relative to other non-sponsored content items for display to users of the social networking system comprises:
displaying the tagged content item in an album view, displayed to one or more of the users of the social networking system more prominently than the one or more of the other of the plurality of content items in the album view.

15. The method of claim 1, further comprising:
responsive to a substitution request from an advertiser associated with the sponsor request, replacing, for display to users of the social networking system, one or more newsfeed stories associated with the tagged content item with one or more substituted newsfeed stories associated with complementary advertisable information to advertisable information represented by the promotional information in the tagged content item.

16. The method of claim 1, further comprising adjusting the ranking of the tagged content item based on one or more quality parameters of the promotional information in the tagged content item.

17. The method of claim 1, wherein the sponsor request includes a bid amount corresponding to a monetary compensation provided by an advertiser to the social networking system if the tagged content is presented to one or more users of the social networking system.

18. The method of claim 1, wherein the content item is generated by a social networking system user.

19. The method of claim 1, further comprising:
receiving a plurality of sponsor requests to promote content posted in a social networking system in exchange for compensation, each sponsor request specifying one or more tags that identify posted content to be sponsored; and
prior to identifying promotional information within the content item:
establishing a connection in the social networking system between a posting user of a plurality of users of the social networking system and the viewing user of the plurality of users; and
receiving from the posting user, a request to post the content item from the posting user to one or more other users of the social networking system who have established a connection to the posting user, the one or more other users comprising the viewing user.

18. A computer system comprising:
a processor; and
memory coupled to the processor, the memory having encoded thereon instructions that, when executed by the processor, cause the processor to:
identify promotional information within a content item posted on a social networking system;
tag the content item with one or more tags representing the promotional information identified in the content item;
match the one or more tags of the tagged content item to one or more tags of a sponsor request to promote content in the social networking system in exchange for compensation, the sponsor request specifying one or more tags that identify posted content to be sponsored;
rank a plurality of content items for display to a viewing user, the plurality of content items including the tagged content item, wherein the instructions that cause the processor to rank increase a ranking of the tagged content item relative to one or more of the other of the plurality of content items based on the tagged content item being tagged with a tag that matches a tag of the sponsor request;
determine one or more of the plurality of content items to present to the viewing user based on the ranking.

19. The system of claim 18, wherein the promotional information corresponds to advertisable information that an advertiser provides compensation to the social networking system to present to social networking system users.

20. The system of claim 18, wherein the content item comprises one or more of: a still image file, an image frame extracted from a videographic file, audio content extracted from a videographic file, an audio file comprising musical recording, an audio file comprising speech, or geospatial content.

21. The system of claim 18, wherein the promotional information comprises one or more of: an image representation of a brand-name, a videographic representation of a brand-name, an audiographic representation of a brand-name, an image representation of a graphical logo, a videographic representation of a trademark, an image representation of a trademark phrase, an audiographic representation of a trademark phrase, or an audiographic representation of a trademark musical theme.

22. A computer program product comprising a non-transitory computer-readable storage medium including instructions that, when executed by a processor, cause the processor to:
identify promotional information within a content item posted on a social networking system;
tag the content item with one or more tags representing the promotional information identified in the content item;
match the one or more tags of the tagged content item to one or more tags of a sponsor request to promote content in the social networking system in exchange for compensation, the sponsor request specifying one or more tags that identify posted content to be sponsored;
rank a plurality of content items for display to a viewing user, the plurality of content items including the tagged content item, wherein the instructions that cause the processor to rank increase a ranking of the tagged content item relative to one or more of the other of the plurality of content items based on the tagged content item being tagged with a tag that matches a tag of the sponsor request;
determine one or more of the plurality of content items to present to the viewing user based on the ranking.

23. The computer program product of claim 22, wherein the instructions further cause the processor to:
identify a statistical representation of user sentiments toward the tagged content item by causing the processor to analyze one or more comments received from social networking system users in conjunction with the tagged content item; and
adjust the ranking of the tagged content item based on the statistical representation of user sentiments toward the tagged content item.

24. The computer program product of claim 22, wherein the instructions further cause the processor to determine one or more of the plurality of content items to present to the viewing user based on the ranking, by causing the processor to:
display the tagged content item in a newsfeed presented to one or more of the users of the social networking system in spatial locations more prominent than display locations for the one or more of the other of the plurality of content items in the newsfeed.

25. The computer program product of claim 22, wherein the instructions further cause the processor to determine one or more of the plurality of content items to present to the viewing user based on the ranking, by causing the processor to:
adjust a weighting of the tagged content item in proportion to weights ascribed to one or more other factors for the tagged content item when compared to corresponding weights ascribed to the one or more other factors for the one or more of the other of the plurality of content items.
